(19) United States
(12) Patent Application Publication
(10) Pub. No.: US 2024/0326366 A1
(43) Pub. Date: Oct. 3, 2024

(54) SEGMENTED CURING RING FOR NPT ELASTOMER BANDS

(71) Applicant: The Goodyear Tire & Rubber Company, Akron, OH (US)

(72) Inventors: Michael James Hogan, Tallmadge, OH (US); John Edward Anderson, Atwater, OH (US); George Michael Stoila, Tallmadge, OH (US)

(21) Appl. No.: 18/191,973

(22) Filed: Mar. 29, 2023

(51) Int. Cl. B29D 30/02

(52) U.S. Cl. CPC B29D 30/02

(57) ABSTRACT

The present disclosure is related to a curing ring that can be utilized in a tire mold to cure elastomer bands for NPTs or for tread band assemblies used in tire retreading. In one or more embodiments, the tire mold can comprise a base plate having a plurality of channels oriented along a radial direction. The tire mold can also comprise a plurality of inner segments configured to engage an inner radius of the elastomer band. Each inner segment includes an optional anchor for reception into a respective channel of the plurality of channels. Also, the plurality of inner segments can be configured to translate along the radial direction. Further, the tire mold can comprise a plurality of outer segments configured to engage an outer radius of the elastomer band.

### FIELD OF THE INVENTION

The present disclosure relates generally to a segmented curing ring assembly for manufacturing elastomer bands for non-pneumatic tires (e.g., shear bands and/or shear band and tread band assemblies) and, more particularly, to a curing ring assembly that can be utilized within a tire mold for curing non-pneumatic tire elastomer bands (e.g., shear bands) using pneumatic tire curing equipment, such as pneumatic tire curing press machines and/or pneumatic tire curing molds.

### BACKGROUND OF THE INVENTION

A non-pneumatic tire (NPT) is an airless tire, also known as a flat-free tire, and is not supported by air pressure to carry the weight of a vehicle. Rather, the treads of an NPT support the weight of the vehicle using a web or spoke design. NPTs can be used on a variety of vehicles, especially where the risk of puncture is high, such as: riding lawn mowers, motorized golf carts, passenger vehicles, trucks, construction equipment, airplanes and/or the like. NPTs are often more durable than conventional pneumatic tires and require less maintenance. These advantages may be especially useful in off-road or hazardous road conditions.

However, the structural difference between NPTs and conventional pneumatic tires inhibits the use of conventional manufacturing equipment in the construction of NPTs. As such, specialized equipment is typically employed to manufacture NPTs, which can be cost prohibitive and/or can limit the availability of NPT manufacturing locations.

### SUMMARY OF THE INVENTION

In accordance with one or more aspects, a tire mold is provided. The tire mold can comprise a base plate having a plurality of channels oriented along a radial direction. The tire mold can also comprise a plurality of inner segments configured to engage an inner radius of the elastomer band. Each inner segment can include an anchor for reception into a respective channel of the plurality of channels. Also, the plurality of inner segments can be configured to translate along the radial direction. Further, the tire mold can comprise a plurality of outer segments configured to engage an outer radius of the elastomer band.

In another aspect, a method for curing a non-pneumatic tire elastomer band is provided. The method can comprise assembling a segmented curing ring comprising a plurality of inner mold segments configured to travel across a base plate along a radial direction. The method can also comprise positioning a green elastomer band between the plurality of inner segments and one or more outer mold segments. Further, the method can comprise exerting an outward pressure on an inner surface of the green elastomer band via the plurality of inner mold segments while exerting an inward pressure on an outer surface of the green elastomer band via the one or more outer mold segments.

In another aspect, an elastomer band curing ring is provided. The elastomer band curing ring can comprise a plurality of plates that are vertically oriented from a base. The plurality of plates can be configured to translate across the channels along a radial direction. Also, the plurality of plates can be positioned adjacent to each other to form an inner molding surface that is substantially flat along an axial direction that is perpendicular to the radial direction.

### Definitions

“Axial” and “axially” mean lines or directions that are parallel to the axis of rotation of the tire.

“Circumferential” means lines or directions extending along the perimeter of the surface of the annular tread perpendicular to the axial direction.

“Green band” means a shear band that has not yet been cured and/or has not had treads added thereupon.

“Inner” or “inwardly” means toward a central axis of the segmented curing ring.

“Outer” or “outwardly” means away from a central axis of the segmented curing ring.

“Non-pneumatic tire” refers to an airless tire, also known as a flat-free tire, and is not supported by air pressure to support the weight.

“Pneumatic Tire” means a laminated mechanical device of generally toroidal shape (usually an open-torus) having beads and a tread and made of rubber, chemicals, fabric and steel or other materials. When mounted on the wheel of a motor vehicle, the tire through its tread provides traction and contains the fluid that sustains the vehicle load.

“Radial” and “radially” are used to mean directions radially toward or away from the axis of rotation of the tire.

“Tread” means a molded rubber component, which includes that portion of the tire that comes into contact with the road when the tire is normally inflated and under normal load. The tread has a depth conventionally measured from the tread outer surface to the bottom of the deepest groove of the tire.

“Tread block” or “Tread element” or “Traction element” means a rib or a block element defined by a shape having adjacent grooves.

### BRIEF DESCRIPTION OF THE DRAWINGS

Although the invention is generally described in the context of these preferred embodiments, it should be understood that the figures are not intended to limit the spirit and scope of the invention to these particular embodiments in any way. The invention will be described by way of example and with reference to the accompanying drawings in which:

FIG. 1 illustrates a diagram of a non-limiting example segmented curing ring that can be utilized with one or more tire curing press machines to generate a cured elastomer band (e.g., NPT shear band and/or shear band and tread assembly) in accordance with one or more embodiments described herein.

FIG. 2A illustrates a top-down perspective of a non-limiting example first type of plate that can be included in a segmented curing ring in accordance with one or more embodiments described herein.

FIGS. 2B-C illustrate side perspectives a non-limiting example first type of plate that can be included in a segmented curing ring in accordance with one or more embodiments described herein.

FIG. 3A illustrates a top-down perspective of a non-limiting example first type of plate that can be included in a segmented curing ring in accordance with one or more embodiments described herein.

FIGS. 3B-C illustrate side perspectives a non-limiting example first type of plate that can be included in a segmented curing ring in accordance with one or more embodiments described herein.

FIGS. 4A-C illustrate perspectives of non-limiting example base structures that can be included in a segmented curing ring in accordance with one or more embodiments described herein.

FIGS. 5A-C illustrate cross-sectional perspectives of an interface between plates and a base of a segmented curing ring in accordance with one or more embodiments described herein.

FIG. 6 illustrates an exploded perspective of a manufacturing process that can utilize a segmented curing ring along with a tire curing press machine to produce cured elastomer bands (e.g., NPT shear bands and/or shear band and tread assemblies) in accordance with one or more embodiments described herein.

FIG. 7 illustrates a partially exploded perspective of a tire mold that can utilize a segmented curing ring along with a tire curing press machine to produce cured elastomer bands (e.g., NPT shear bands and/or shear band and tread assemblies) in accordance with one or more embodiments described herein.

FIG. 8A illustrates another partially exploded perspective of a tire mold that can utilize a segmented curing ring along with a tire curing press machine to produce cured elastomer bands (e.g., NPT shear bands and/or shear band and tread assemblies) in accordance with one or more embodiments described herein.

FIG. 8B illustrates a cross-sectional perspective of a portion of a tire mold during a curing process to form an elastomer band for an NPT in accordance with one or more embodiments described herein.

FIG. 9 illustrates a perspective of one or more outer mold segments that can be utilized to impart a tread pattern onto the outer surface of an elastomer band (e.g., an NPT shear band) during a curing process in accordance with one or more embodiments described herein.

### DETAILED DESCRIPTION

The present disclosure relates generally to methods and/or apparatuses for producing cured elastomer bands (e.g., shear bands) having a flat inner surface for use in non-pneumatic tires, as well as other tire applications having similar requirements. In particular, the present disclosure relates generally to adapting pneumatic tire manufacturing methods and apparatuses for producing NPTs that require an elastomer band (e.g., a shear band) with a flat inner interface. Such elastomer bands (e.g., shear bands) may be useful in NPT applications or other applications requiring an elastomer band (e.g., shear band) having a flat inner surface.

NPTs typically comprise a hub that is attachable to a vehicle's axis. Extending from the hub is a plurality of spokes, which further attach to a shear band. The spokes can be arranged in a pattern and are deformable by tension, buckling, compression, and/or bending during rolling of the NPT. The shear band can be a multi-layer structure with a tread band, which interfaces with the ground during operation of the NPT. The tension of the shear band on the spokes, and the strength of the spokes themselves, replaces the air pressure utilized by a pneumatic tire. Shear bands can be made from a polymer such as polyurethane and/or a rubber. To facilitate the connection between the spokes and the shear band, it is desirable for an inner surface of the shear band (e.g., a surface facing the axis of the NPT) to be flat along the axial direction of the tire. A curved, or deformed, inner surface can necessitate non-uniform spoke geometries, which in turn can cause manufacturing and/or performance challenges.

However, conventional manufacturing techniques and/or equipment used to produce pneumatic tires form a curved inner surface in the tire's carcass. The manufacturing of pneumatic tires for motor vehicles of nearly all sizes entails the steps of creating a carcass and attaching thereto the tread and sidewalls, which are made of uncured rubber. The combination of the carcass, the tread, and the sidewalls, prior to curing of the rubber, is called a “green tire.” The final step in manufacturing pneumatic tires is the insertion of the green tire into a tire mold, where an inflatable bladder is used to press the green tire against the mold to achieve a desired shape and/or tread pattern. The tire mold is then heated to a sufficiently high temperature to bring about the curing process.

Typically, use of the bladder results in a curved inner surface on the tire along the axial direction. Thus, attempts to utilize pneumatic tire molds and bladders to manufacture NPTs can result in a shear band with an undesirable curve in the inner surface. As such, conventional NPT manufacturing techniques fail to use or adapt existing pneumatic tire molding technology to produce shear bands suitable for use in NPTs and other types of tires that require a shear band having a flat inner surface in the axial direction.

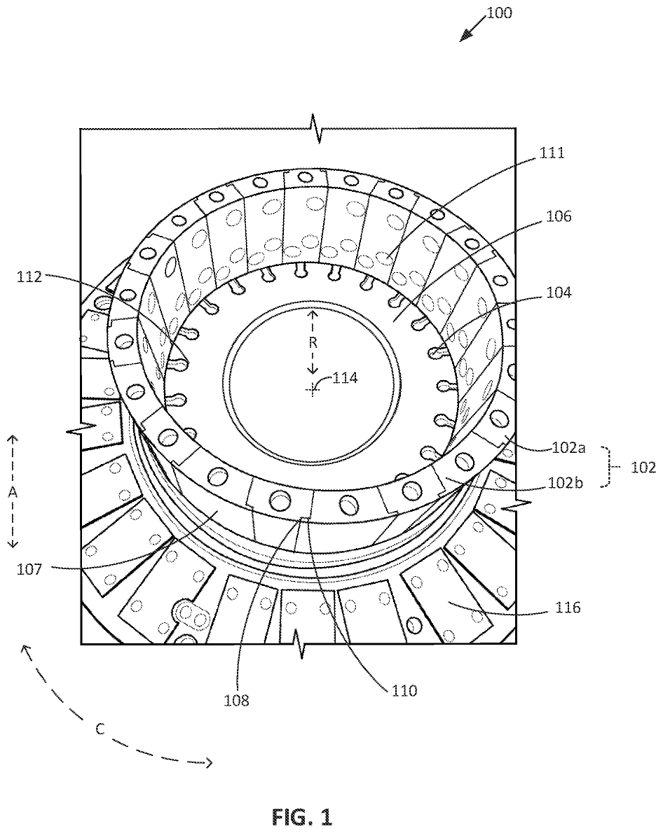

In various embodiments described herein, the apparatuses and/or methods of the present disclosure have several advantages including the incorporation of pneumatic tire molding and curing technology into the production of NPTs, which provides for cost savings, especially in terms of additional capital investment, as well as economies of scale. The structure, operation, and advantages of the present invention will become apparent upon consideration of the description herein below taken in conjunction with the accompanying figures (FIGS. 1-9).

Additionally, various embodiments described herein can exhibit advantages over conventional compression processes utilized to manufacture elastomer bands (e.g., shear bands) for NPTs by enabling a venting of the molded part and/or stricter tolerance control over the dimensions of the resultant elastomer band (e.g., NPT shear band, which can include a tread pattern). For instance, in accordance with the various embodiments described herein, mold venting techniques utilized with pneumatic tires can be utilized to manufacture the NPT shear bands while precluding the trimming works required with compression molding processes typically utilized for NPT shear band manufacturing. Further, conventional compression processes require the mold to be bumped open during the curing stage to prevent rupture of the molded components. For example, the pressure of the rubber during the compression process can reach 4000 pounds per square inch (psi); thus, the mold is typically bumped open during the curing to relieve the pressure, then the mold is re-closed. As such, the inner diameter of the shear band is preserved to a tolerance of, for example, about 0.002 inches; however, the outer diameter of the shear band can vary up to, for example, about 0.015 inches (e.g., due releasing the mold). Advantageously, the apparatuses, systems, and/or methods described herein can enable the inner and outer diameter of the NPT shear band to remain within, for example, about a 0.004 inch tolerance, where an inflatable bladder can be utilized to compensate for the high hydraulic pressure utilized by the conventional compression process. Thus, the dimensions of the shear band can more closely match targeted dimensions (e.g., which can account for shrink rates of the rubber to meet the design dimensions of the resultant shear band).

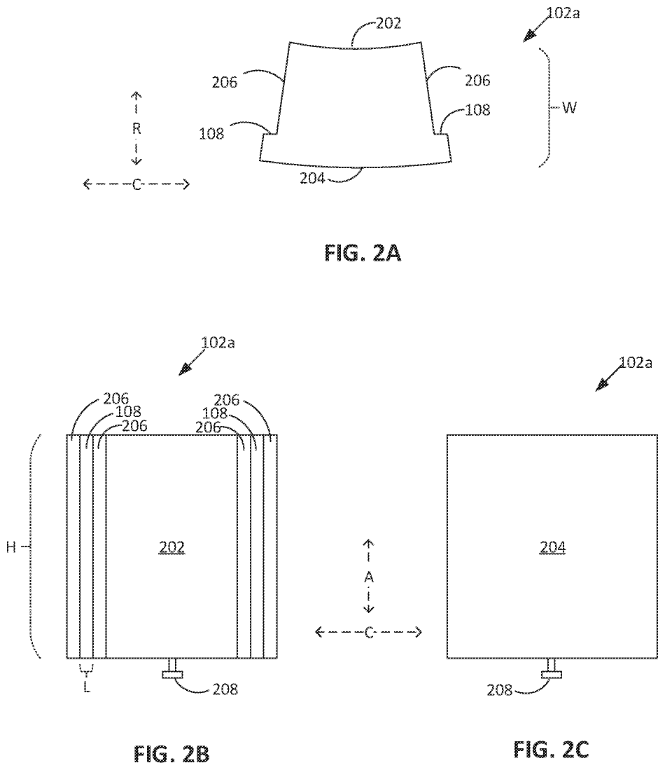

FIG. 1 depicts a segmented curing ring 100 that can be utilized to manufacture one or more cured elastomer bands (e.g., NPT shear bands and/or shear band and tread band assemblies) having a flat interior surface. For example, the segmented curing ring 100 can be a tire curing ring, such as a shear band curing ring. As shown in FIG. 1, the segmented curing ring 100 is formed by a plurality of plates 102 that are positioned at a distal radial end of channels 104 in the base 106 of the segmented curing ring 100. For example, the plurality of plates 102 can serve as a plurality of inner mold segments, where one or more molding segments of a tire curing press machine can serve as a plurality of outer mold segments during the curing process in accordance with one or more embodiments described herein. The base 106 and the plates 102 are described in more detail below with respect to FIGS. 2-8.

The plurality of plates 102 are oriented vertically along what will be an axial direction “A” of the NPT. When the plurality of plates 102 are placed in a radial orientation, an outer surface 107 of the plates 102, along what will be the circumferential direction “C” of the NPT, defines an interior geometry of a resultant elastomer band (e.g., shear band and/or shear band and tread band assembly) during the manufacturing process. For example, the outer surface 107 can serve as an inner molding surface, where the outer surface 107 can be substantially flat along the axial direction A and/or substantially continuous along the circumferential direction C. As shown in FIG. 1, the plurality of plates 102 can comprise a first type of plate 102a and a second type of plate 102b, which can interlock with each other via projections 108 and recesses 110 positioned along the sidewalls of the plurality of plates 102. For instance, the first type of plates 102a can include projections 108 extending from the sidewalls of the first type of plates 102a in the circumferential direction C. The second type of plates 102b can include recesses 110 positioned in the sidewalls second type of plates 102b along the circumferential direction C. In various embodiments, the plurality of plates 102 can be composed of a metal or polymer material. Example materials that can compose the plurality of plates 102 include, but are not limited to: aluminum, steel, carbon fiber, nylon, ductile iron, epoxy, a combination thereof, and/or the like. In one or more embodiments, the plurality of plates 102 can have one or more voids 111 to manage thermodynamics or weight of the segmented curing ring 100. For instance, FIG. 1 depicts example plates 102 having voids 111 on an inner surface and/or a top surface. The one or more voids 111 can extend into the body of the plates 102 without translating to the outer surface 107. Alternatively, the plates 102 can be free of depressions 111.

As shown in FIG. 1, the base 106 can comprise a plurality of channels 104 oriented in what will be the radial direction “R” of the NPT. The channels 104 can be recessed into the base 106 and can extend through the base 106 along the radial direction R. In various embodiments, respective plates 102 can at least partially reside within respective channels 104. In various embodiments, the plurality of plates 102 can be composed of a metal or polymer material. Example materials that can compose the base 106 include, but are not limited to: aluminum, steel, carbon fiber, nylon, ductile iron, epoxy, a combination thereof, and/or the like.

As described further herein, the plurality of plates 102 can be initially placed into the base 106 via a first end 112 (e.g. an inner end) of the plurality of channels 104, which can be closest to a central axis 114 of the base 106. During the shear band manufacturing process, the plurality of segmented plates 102 can then be pushed along the radial direction R, where the plurality of channels 104 can guide the travel of the plurality of plates 102 and maintain a connection between the plates 102 and the base 106. Thereby, the plurality of plates 102 can travel (e.g., translate) along the channels 104 between a collapsed state of the segmented curing ring 100 and an expanded state of the segmented curing ring 100. In various embodiments, the number of plates 102 included in the segmented curing ring 100 can vary depending on the desired circumference of the resultant shear band. In some embodiments, the number of plates 102 comprising the segmented curing ring 100 can range from, for example, greater than or equal to 3 and less than or equal to 40.

As described further herein, an inflatable bladder can be utilized to translate the plurality of plates 102 along the channels 104 and press the outer surface 107 against the inner diameter of a green band during a curing process that results in an elastomer band (e.g., a NPT shear band and/or shear band and tread band assembly). For example, the green band can be positioned between the plates 102 and a curing press machine positioned on one or more wear plates 116 at least partially surrounding the plurality of plates 102 (e.g., adjacent to the outer surface 107). The outer surface 107 of the segmented curing ring 100 can ensure that the inner diameter surface of the resultant elastomer band (e.g., NPT shear band) remains flat, while the outer diameter surface of the resultant elastomer band (e.g., NPT shear band) can be molded to provide a tread pattern and can have a spherical molded radius. The flat inner diameter surface of the resultant elastomer band (e.g., NPT shear band) can facilitate coupling with one or more spokes, while the spherical molded radius of the outer diameter surface of the resultant elastomer band (e.g., NPT shear band) can facilitate foot print pressure and tread wear control of the NPT. Absent the plurality of plates 102, the inflatable bladder could deform during the curing process and the inner diameter surface of the resultant elastomer band (e.g., NPT shear band) would follow the spherical molded radius of the outer diameter surface of the resultant elastomer band (e.g., NPT shear band).

In some conventional NPT shear band manufacturing techniques, a metal ring is utilized to provide a flat molding surface for the inner diameter surface of the NPT shear band. For example, the metal ring can be expandable (e.g., by about two inches), and the metal ring can allow the inner diameter surface of the resultant NPT shear band to be uncoupled from the spherical mold radius imparted to the outer diameter surface of the NPT shear band. However, minor deformities in the roundness of the metal ring can result in non-uniform forces exhibited by the NPT shear band. For instance, the spring rate of the shear band can be, for example, hundreds of pounds per 0.001 inches; thus, where the metal ring is 0.002 inches out of round at a deformed location, an additional 200 pounds of force can be created at the position molded by the deformed location of the metal ring. Advantageously, the plurality of plates 102 can resist deformations that the metal ring may be susceptible to during the curing process (e.g., due to at least the greater rigidity of the plates 102).

FIG. 2A illustrates a top-down view of the first type of plates 102a. As shown in FIG. 2A, the first type of plates 102a can be tapered along the radial direction R. For example, a first inner surface 202 of the first type of plates 102a can face towards the central axis 114 along the radial direction R, whereas a first opposing surface 204 of the first type of plates 102a can form a portion of the outer surface 107 of the segmented curing ring 100. The first inner surface 202 of the first type of plates 102a can be narrower along the circumferential direction C than the first opposing surface 204. In some embodiments, the first type of plates 102a may have voids 111 (e.g., on the first inner surface 202) to manage thermodynamics or weight of the segmented curing ring 100, if desired. Additionally, the first type of plates 102a can include a first set of slanted sidewalls 206 that can include the projections 108 extending outward, away from the body of the first type of plate 102a, along the circumferential direction C. In one or more embodiments, each sidewall of the first set of slanted sidewalls 206 can include a projection 108. In various embodiments, the first type of plates 102a can have a width “W” along the radial direction R ranging from, for example, greater than or equal to about 0.5 inches and less than or equal to about 4 inches.

FIG. 2B illustrates a side perspective of the first inner surface 202 of the first type of plates 102a. In various embodiments, first type of plates 102a can extend along the axial direction A to a height “H” ranging from, for example, greater than or equal to about 1 inch and less than or equal to about 21 inches. Additionally, the projections 108 can extend from a body of the first type of plates 102a along the circumferential direction C to a length L ranging from, for example, less than or equal to about 1 inch.

Further, as shown in FIG. 2B, the first type of plates 102a can include one or more anchors 208 extending from a bottom surface of the first type of plates 102a. In various embodiments, the anchors 208 can have a geometry designed to fit within the one or more channels 104. FIG. 2B illustrates an example embodiment in which the one or more anchors 208 have a “T-shape” architecture; however, alternate architectures are also envisaged. For example, in one or more embodiments, the anchors 208 can have a spherical or polygonal shape that complements an interior cross-section of the one or more channels 104, as described further herein.

FIG. 2C illustrates a side perspective of the first opposing surface 204. In one or more embodiments, the first opposing surface 204 can be flat along the axial direction A (e.g., along the vertical orientation of the segmented curing tire 100). In various embodiments, the first opposing surface 204 (e.g., a portion of the outer surface 107 of the segmented curing ring 100) can also be smooth (e.g., free of indentations and/or grooves).

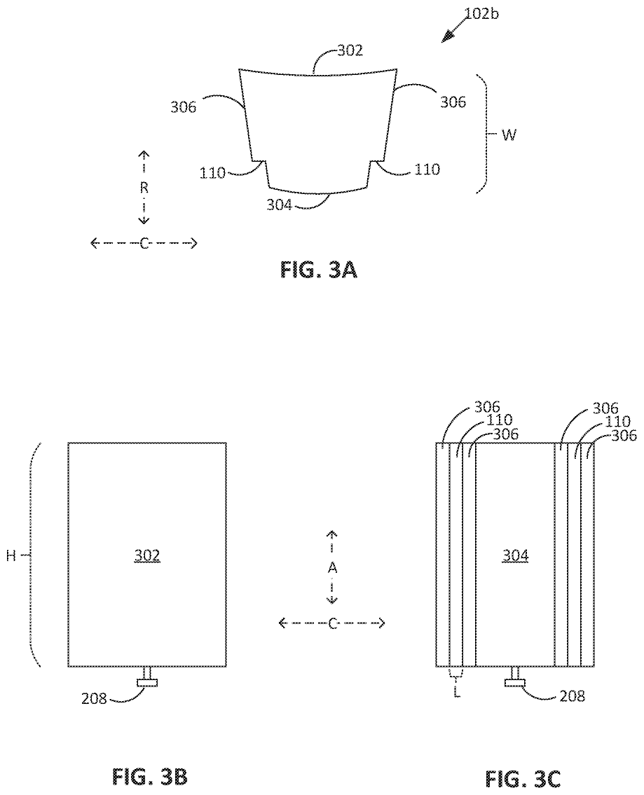

FIG. 3A illustrates a top-down view of the second type of plates 102b. As shown in FIG. 3A, the second type of plates 102b can have a complementary (e.g., an opposing) tapering along the radial direction R to the tapering of the first type of plates 102a. A second inner surface 302 of the second type of plates 102b can face towards the central axis 114 along the radial direction R, whereas a second opposing surface 304 of the second type of plates 102b can form another portion of the outer surface 107 of the segmented curing ring 100. The second inner surface 302 of the second type of plates 102b can be wider along the circumferential direction C than the second opposing surface 304. Additionally, the second type of plates 102b can include a second set of slanted sidewalls 306 that can include the recesses 110 extending into the second set of slanted sidewalls 306 toward the body of the second type of plate 102b, along the circumferential direction C. In one or more embodiments, each sidewall of the second set of slanted sidewalls 306 can include one or more recesses 110. In various embodiments, the second type of plates 102b can have an equivalent width “W” along the radial direction R as the width of the first type of plates 102a.

FIG. 3B illustrates a side perspective of the second inner surface 302 of the second type of plates 102b. In various embodiments, second type of plates 102b can extend along the axial direction A to an equivalent height H as the first type of plates 102a. Further, as shown in FIG. 3B, the second type of plates 102b can also include the one or more anchors 208 extending from a bottom surface of the second type of plates 102b. In some embodiments, the second type of plates 102b may have voids and/or depressions (e.g., on first inner surface 302) to manage thermodynamics and/or weight of the segmented curing ring 100, if desired.

FIG. 3C illustrates a side perspective of the second opposing surface 304. In one or more embodiments, the second opposing surface 304 can be flat along the axial direction A (e.g., along the vertical orientation of the segmented curing tire 100). Additionally, as shown in FIG. 3C, the recesses 110 can extend along the circumferential direction C, from the second set of slanted sidewalls 306, by a length L equivalent to that of the projections 108. In various embodiments, the second opposing surface 304 (e.g., a portion of the outer surface 107 of the segmented curing ring 100) can also be smooth (e.g., free of indentations and/or grooves).

As shown in FIG. 1, the one or more first type of plates 102a can be positioned adjacent to the one or more second type of plates 102b along the circumferential direction C. Thereby, the projections 108 of the first type of plate 102a can rest within the recesses 110 of the second type of plate 102b. Additionally, in one or more embodiments, the slope of the first set of slanted sidewalls 206 can match the slope of the second set of slanted sidewalls 306. Thus, as the plurality of plates 102 slide along the channels 104 to the expanded state of the segmented curing ring 100, the complementary tapering of the first type of plates 102a and the second type of plates 102b can enable the plates 102 to be positioned tightly together along the expanded circumference. In various embodiments, the number of plates 102 comprising the segmented curing ring 100 can be such that they create a continuous circle when engaged.

Additionally, the first opposing surface 204 of the first type of plates 102a and the second opposing surface 304 of the second type of plates 102b can be curved such that, when the segmented curing ring 100 is the expanded state, the plurality of first opposing surfaces 204 and the plurality of second opposing surface 304 collectively form an outer surface 107 having a roundness that corresponds to the desired inner diameter of a resultant elastomer band (e.g., NPT shear band and/or shear band and tread band assembly) cured using the segmented curing ring 100. For example, the curvature of the first opposing surface 204 and the second opposing surface 304 can be defined such that the outer surface 107 has a circular geometry of uniform roundness (e.g., a circle with a uniform diameter). Accordingly, the curvature of the first opposing surface 204 and the second opposing surface 304 can be based on the number of plates 102 and the desired circumference of the outer surface 107 (e.g., along the circumferential direction C) while the segmented curing ring 100 is the expanded state.

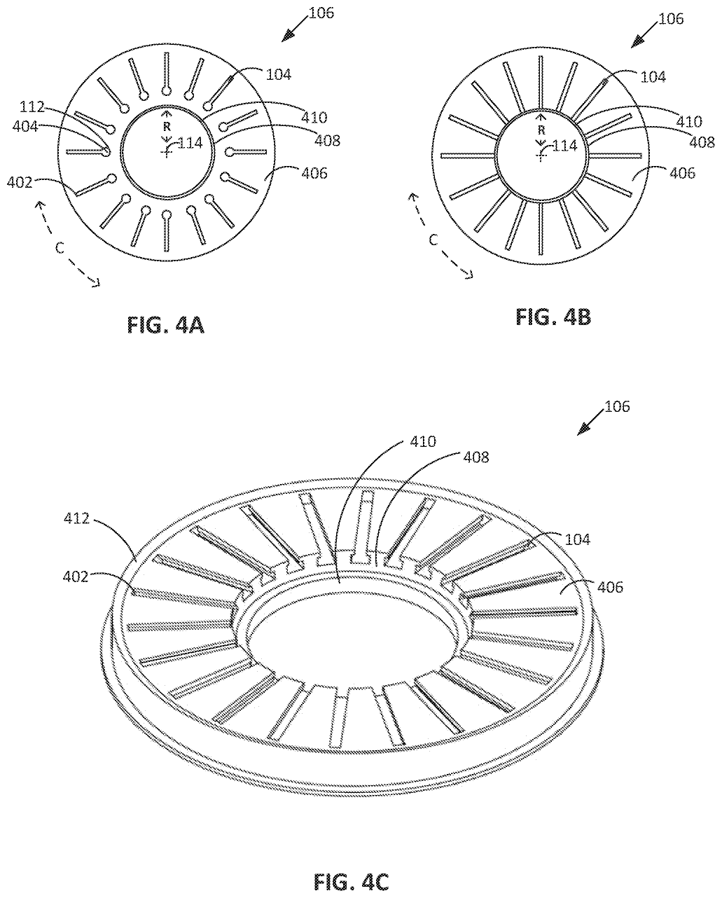

FIGS. 4A and 4B illustrate top-down views of example bases 106 of the segmented curing ring 100. In various embodiments, the base 106 has a plurality of channels 104 extending from a first end 112 to a second end 402 along the radial direction R. As shown in FIGS. 4A and 4B, the second end 402 can be a furthest end of the channels from the central axis 114. FIG. 4A depicts a first example base 106 in which the first end 112 terminates at a cavity 404 in the top surface 406 of the base 106. In various embodiments, the cavity 404 can have a larger diameter or width than the width (e.g., along the circumferential direction C) of the channels 104. Thereby, the anchors 208 can be inserted into the cavities 404; however, once the anchors 208 slide radially into the channels 104, the narrowed width of the channels 104 can prevent the anchors 208 from exiting the channel 104 through the top surface 406.

FIG. 4B depicts a second example base 106 in which the channels 104 can have a uniform, or substantially uniform, width (e.g., along the circumferential direction C), and the anchors 208 can enter the channels 104 at the first end 112 via an opening in the inner sidewall 408 of the base 106. As shown in FIGS. 4A and 4B, the base 106 can include a void proximal to the central axis 114, where the void can be defined by an inner sidewall 408 of the base 106. In one or more embodiments, the anchors 208 can be positioned within the void and then moved along the radial direction R into openings in the inner sidewall 408 that are in fluid communication with the channels 104. As described above, once the anchors 208 have entered the channels 104, the width of the channels 104 at the top surface 406 can be narrower than a width of the anchors 208; thereby, the anchors 208 can be prevented from exiting the channels 104 via the top surface 406.

Each channel 104 is capable of receiving an anchor 208 of a plate 102. For example, the plurality of plates 102 can attach to the channels 104 through the one or more anchors 208, which can have geometry that is complementary to an inner cavity of the channels 104. The anchors 208 can be inserted into the channels 104 and thereby hold the plurality of plates 102 in their vertical orientation relative to the base 106. Preferably, the interface between the anchors 208 and channels 104 is secure so that the connection of the plates 102 to the base 106 does not detach during operation of the methods disclosed herein. Further, the interface between the anchors 208 and the channels 104 enables the plates 102 to translate radially from an inner portion of the base 106 (e.g., near the central axis 114) to an outer portion of the base 106 (e.g., outward in the radial direction R) without being detached from the base 106. The plurality of plates 102 can be situated along the channels 104 to provide a given geometry to the outer surface 107 of the segmented curing ring 100.

In one or more embodiments, the base 106 can further comprise a flange 410 positioned adjacent to the inner sidewall 408 (e.g., as shown in FIGS. 4A and 4B). For instance, the flange 410 can facilitate securing the base 106 to a mounting station and/or other equipment utilized in the manufacturing of an NPT.

FIG. 4C depicts another view of the example base 106 shown in FIG. 4B. As discussed herein, an opening in the inner sidewall 408 of the base 106 can render the plurality of channels 104 accessible along the radial direction R, from the central axis 114 towards the perimeter of the base 106. Additionally, in one or more embodiments the base 106 can include a ridge 412 positioned about the circumference of the base 106, which can abut the plurality of plates 102 when the segmented curing ring 100 is in the expanded state.

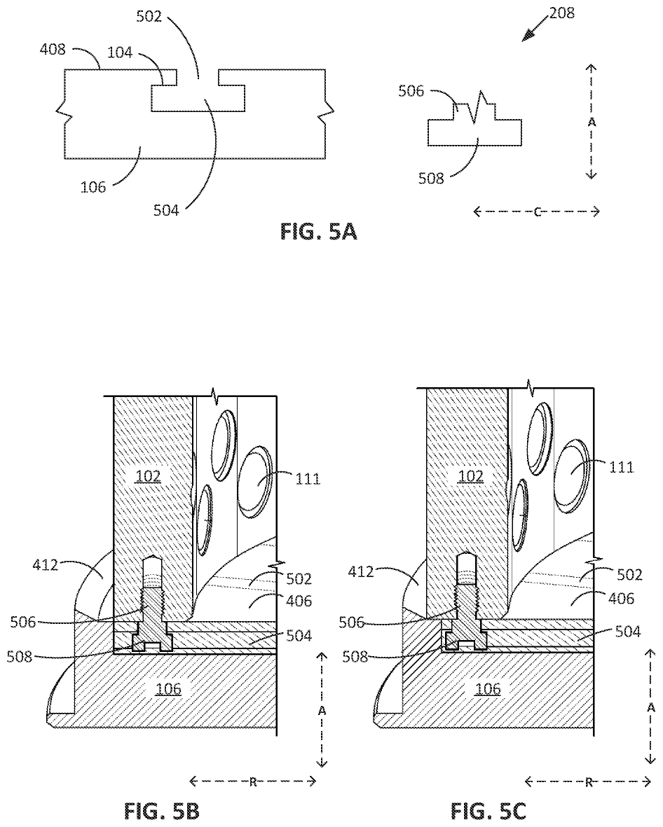

FIG. 5A depicts a cross-sectional view of an example portion of the base 106 and an example anchor 208. As shown in FIG. 5A, an interior geometry of the channels 104 can include a channel opening 502 and a channel body 504. The channel opening 502 can be at the top surface 406 of the base 106. In one or more embodiments, the channel opening 502 can enable a stem 506 of the anchor 208 to extend through the top surface 406 of the base 106 while traveling along the channels 104. The channel body 504 can be located within the base 106 and can accommodate the architecture of a distal end 508 of the anchors 208. For instance, the distal end 508 of the anchor 208 can have a width (e.g., along the circumferential direction C) that is greater than the width of the stem 506; whereas the width of the channel opening 502 can be narrower than a width of the channel body 504. Thereby, once positioned within the channel body 504, the anchor 208 can travel (e.g., translate) along the radial direction R, but not the axial direction A.

FIGS. 5B-C illustrate cross-sectional views of a portion of a plate 102 engaged with a portion of the base 106. For example, FIG. 5B depicts a cross-sectional view of the plate 102 approaching the expanded state of the segmented curing ring 100 (e.g., at a partially expanded state). FIG. 5C depicts a cross-sectional view of the plate 102 at the fully expanded state of the segmented curing ring 100. In one or more embodiments, the base 106 can further include a ridge 412 positioned at the circumference of the base 106. The ridge 412 can facilitate placement and/or support of the plurality of plates 102 while the segmented curing ring 100 is in the expanded state. For instance, FIG. 5B depicts a cross-section of the channel 104 along the radial direction R. As shown in FIG. 5B, the anchor 208 (e.g., the stem 506 of the anchor 208) can extend through the top surface 406 of the base 106 and into the channel body 504. In one or more embodiments, the anchor 208 can be a fastener (e.g., a screw or bolt) extending from the bottom of the plate 102, where the head of the fastener (e.g., the screw head or bolt head) can be the distal end 508 of the anchor 208. For instance, FIGS. 5B-5C depict an example embodiment in which the anchor 208 is a fastener screwed into a bottom of the associated plate 102 (e.g., via a thread engagement between the stem 506 of the anchor 208 and an inner cavity located in the bottom of the plate 102).

Between FIGS. 5B and 5C, the anchor 208 is engaged within an example channel 104 and is shown translating along the radial direction R towards the ridge 412 to achieve the fully expanded state of the segmented curing ring 100; thus illustrating movement of the vertical oriented plate 102 along the channel 104 vis-à-vis the interface between the anchor 208 and channel body 504. In an exemplary embodiment, the anchor 208 is a bolt aligned with the vertical axis of the plate 102 (e.g., along the axial direction A) and extends from the plate 102 into the channel 104 of the base 106. Suitable anchor 208 and channel body 504 geometries should be capable of securing the plates 102 to the base 106 in a desired configuration.

In one or more embodiments, the channels 104 can further house one or more springs (not shown) to assist in demolding the plurality of plates 102 from the resultant elastomer band (e.g., NPT shear band and/or shear band and tread band assembly) once the curing process is complete. For example, one or more springs can be positioned within the channel body 504 at the second end 402 of the channels 104. The springs can bias the one or more anchors 208 away from the radial edge of the base 106 and toward the central axis 114. During the curing process, the plurality of plates 102 can be translated to the second end 402 of the channels 104, where the spring can be compressed via the expansion force provided by an inflatable bladder that moves the plates 102. Once the curing process is complete, the bladder can be deflated, thereby relieving the expansion force and enabling the springs to decompress by forcing the plurality plates 102 towards the central axis 114 and away from the resultant elastomer band (e.g., NPT shear band and/or shear band and tread band assembly).

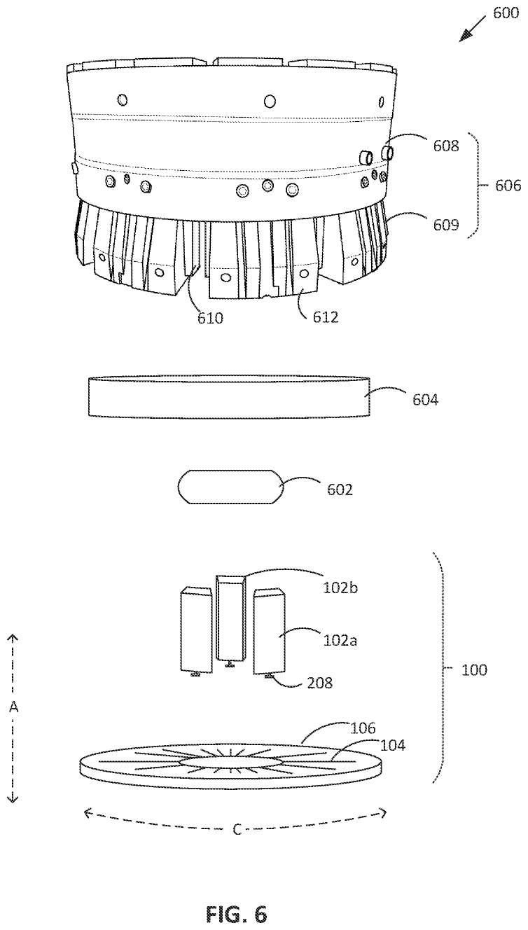

FIG. 6 illustrates an exploded view of a manufacturing process 600 that can be implemented using the segmented curing ring 100 for curing an elastomer band (e.g., NPT shear band and/or shear band and tread band assembly) in accordance with one or more embodiments described herein. During an example of the manufacturing process 600 for an elastomer band (e.g., NPT shear band and/or shear band and tread band assembly) one or more of the following steps can be practiced using the segmented curing ring 100. One of ordinary skill in the art will recognize that the manufacturing process 600 is not limited to specific order described below. Rather, one or more the manufacturing features can be practiced in an alternate order.

First, the plurality of plates 102 can be inserted into the channels 104 of the base 106 to assemble the segmented curing ring 100 shown in FIG. 1. For example, the plurality of plates 102 can serve as a plurality of inner mold segments in accordance with one or more embodiments described herein. As exemplified in FIG. 1, the plates 102 can be inserted into a first end 112 of the channels 104, nearest the central axis 114 of the base 106. For instance, the plates 102 can be inserted into the base 106 such that the anchors 208 are positioned into the cavities 404 of the channels 104. In another instance, the plates 102 can be inserted into the base 106 by positioning the plates 102 into the middle void of the base 106 and then moving the plates 102 in the radial direction R such that the anchors 208 enter openings in the inner sidewall 408 of the base 106 to engage the channel bodies 504.

While three plates 102 are shown in the example illustration of FIG. 6, each of the plurality of plates 102 can be inserted into the base 106 at this stage of the manufacturing process 600. In one or more embodiments, the plates 102 can be inserted into the channels 104 in a clockwise or counter-clockwise sequence along the circumferential direction C, alternating between the first type of plates 102a and the second type of plates 102b.

Next, a bladder 602 can be positioned at, or in proximity to, the central axis 114 of the base 106. Any bladder 602 suitable for conventional pneumatic tire curing may be used in the methods of this disclosure. For example, the bladder 602 can be inflatable, and can be composed of an elastomeric material (e.g., a rubber, such as carbon black). At this stage of the manufacturing process 600, the bladder 602 can be in a collapsed, non-inflated or partially inflated state. Additionally, the bladder 602 can be positioned on the top surface 406 and/or the flange 410 of the base 106.

Next, a green band 604 can be placed on the base 106 surrounding the plurality of plates 102 and/or the bladder 602. The green band 604 can be composed of non-cured components of the NPT shear band to result from the manufacturing process 600. In one or more embodiments, the green band 604 can have a circumference that is equal to, or slightly less than, the circumference of the outer surface 107 when the segmented curing ring 100 is in the expanded state.

Next, the bladder 602 can be inflated so that the plurality of plates 102 are pushed radially along the channels 104 of the base 106 in an outward trajectory along the radial direction R toward the perimeter of the base 106. For example, the bladder 602 can be inflated until the plates 102 reach the ridge 510 of the base 106 and/or the second end 402 of the channels 104. Thus, inflation of the bladder 602 can cause the plurality of plates 102 to travel (e.g., translate) to their position within the expanded state of the segmented curing ring 100. As a result of the bladder 602 inflation, an outer surface 107 of the segmented curing ring 100 can be pressed against an inner surface of the green band 604. In one or more embodiments, inflation of the bladder 602 can force the plurality of plate 102 to slightly stretch the green band 604 along the radial direction. In one or more embodiments, the bladder 602 can be initially inflated to a holding pressure and then further inflated later in the manufacturing process to a higher pressure. For example, the holding pressure can serve to hold the plates 102 in the expanded state, or a partially expanded state; while the bladder 602 can be further inflated once one or more molds fully enclose the green band 604 (e.g., as described further herein). In one or more embodiments, the bladder 602 can be initially inflated to the holding pressure prior to placement of the green band 604 on the segmented curing ring 100 such that the plurality of plates 102 are translated to a partially expanded state, where the circumference of the outer surface 107 is smaller than the inner diameter of the green band 604. Subsequently, the bladder 602 can be further inflated, thereby translating the plurality of plates 102 to the fully expanded state, once one or more molds are positioned around the green band 604 (e.g., as described further herein).

Green bands 604 suitable for use in the present disclosure may be comprised of one or more materials including, but not limited to: neoprene (polychloroprene), polybutadiene (including cis-1,4-polybutadiene), polyisoprene (including cis-1,4-polyisoprene) (natural or synthetic), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM) (e.g., ethylene/propylene/dicyclopentadiene terpolymers), alkoxy-silyl end functionalized solution polymerized polymers (styrene-butadiene rubber, polybutadiene rubber, isoprene butadiene rubber, and styrene isoprene butadiene rubber), silicon-coupled, tin-coupled star-branched polymers, the like, and any combination thereof.

In some embodiments, the green band 604 may have a thickness (e.g., extending along the radial direction R when positioned around the plates 102) ranging, for example, from greater than or equal to about 0.1 inches and less than or equal to about 2 inches.

A tire curing press machine 606 can then be positioned over the green band 604, segmented curing ring 100, and bladder 602. The tire curing press machine 606 can be any type of press suitable for curing pneumatic tires. For example, the tire curing press machine 606 can cure the green band 604 through the application of heat (e.g., via steam) and/or pressure. In various embodiments, operation of the tire curing press machine 606 can cure the components of the green band 604 and/or can impart a tread pattern into an outer surface of the green band 604 (e.g., a side facing away from the segmented curing ring 100); thereby resulting in the final form of the resultant elastomer band (e.g., NPT shear band and/or shear band and tread band assembly). For instance, in one or more embodiments the tire curing press machine 606 can cure the green band 604 at an internal curing pressure ranging from, for example, greater than or equal to about 150 psi and less than or equal to about 300 psi. In various embodiments, the curing energy can be comprised of heat conducted through the thickness of the plurality of plates 102.

FIG. 6 depicts an example tire curing press machine 606 comprising an actuator 608 and one or more segmented tire molds 609 (e.g., a pneumatic tire segmented tire mold). As shown in FIG. 6, the segmented tire molds 609 can be comprised of a molding segments 610 (e.g., which can face the green band 604 when the tire curing press machine 606 is placed around the segmented curing ring 100) and a wedged surface 612. In one or more embodiments, the molding segments 610 can have a spherical radius to impart a molded radius to an outer diameter surface (e.g., an outer surface) of the resultant elastomer band (e.g., NPT shear band and/or shear band and tread band assembly). In accordance with various embodiments described herein, the one or more molding segments 610 can serve as one or more outer mold segments during the manufacturing process 600. The actuator 608 is preferably a conventional actuator that may be useful in pneumatic tire molding processes. For example, the actuator 608 can be circular in shape and capable of accommodating the one or more segmented tire molds 609.

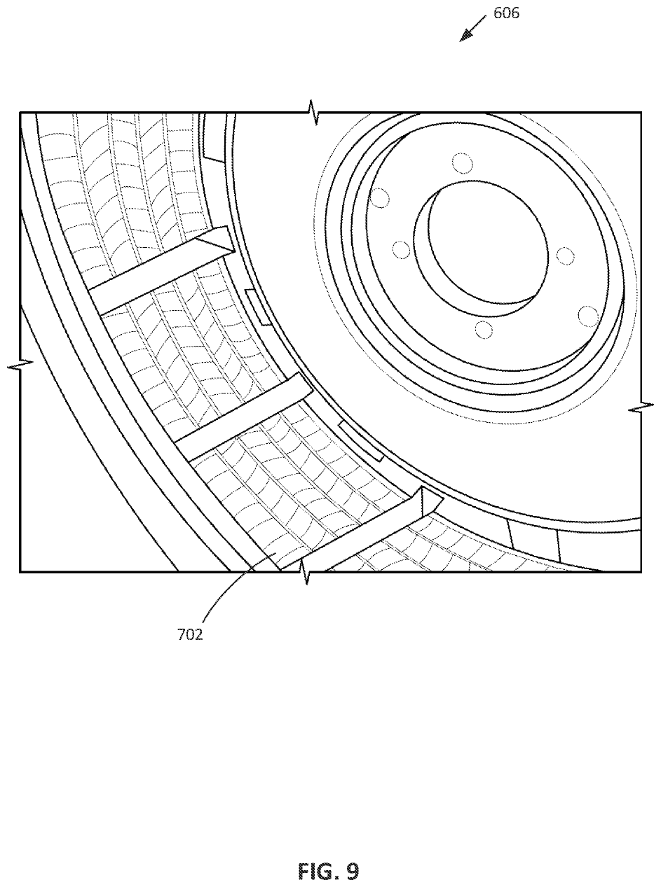

As the actuator 608 presses downward to the base of the segmented tire mold 609, the actuator 608 can engage the wedged surfaces 612 such that the slope of the wedged surfaces 612 causes the segmented tire mold 609 to be pushed inwardly along the radial direction R. As the segmented tire mold 609 is pushed inwardly, the molding segments 610 move toward each other and the green band 604 (e.g., where the green band 604 is positioned around the outer surface 107 of the segmented curing ring 100, as described above). For instance, FIG. 6 depicts a separation between adjacent molding segments 610, where activation of the actuator 608 can bring the segments radially toward each other to engage the green band 604. Thereby, as the actuator 608 is activated, the molding segment 610 is pressed inwardly and against the outer surface of the green band 604. The molding segment 610 can include a surface with an indentation pattern to impart indents and/or ridges into the outer surface of the green band 604 and thereby form a tread pattern (e.g., as shown in FIG. 9).

Further, as the molding segment 610 is pressed against the outer surface of the green band 604, the inner surface of the green band 604 can be supported by the segmented curing ring 100, which in turn is maintained in its expanded state due to the pressure provided by the inflated bladder 602. Additionally, while the green band 604 is being pressed between the inner surface of the molding segment 610 and the outer surface 107 of the segmented curing ring 100, the tire curing press machine 606 can heat the green band 604 to a curing temperature. The temperature and pressure provided by the tire pressing machine 606 can impart a tread pattern on the outer surface of the resultant NPT shear band, while the outer surface 107 of the segmented curing ring 100 can impart a flat inner surface to the resultant NPT shear band.

Following operation of the tire curing press machine 606, the bladder 602 can be deflated, and the plates 102 can travel inwardly along the radial direction R about the channels 104; thereby releasing the resultant NPT shear band from a pressurized (e.g., stretched) state. The resultant shear bands may be used in NPT applications in addition to any other applications that require a shear band having a smooth inner surface. Advantageously, the segmented curing ring 100 can be utilized with tire curing press machines 606 employed during pneumatic tire curing processes (e.g., including the use of pneumatic tire segmented curing molds 609) to cure NPT shear bands. Additionally, the tire curing press machines 606 can utilize molding segments 610 capable of producing a wider range of NPT shear band dimensions than typically available to shear bands formed from conventional compression molding processes. For instance, various embodiments described herein can achieve a resultant NPT shear band having an outer diameter (e.g., along the radial direction R) of up to 34 inches (e.g., up to 32 inches, or up to 29 inches). Also, while FIG. 6 exemplifies the manufacturing process 600 utilizing a segmented mold curing press, embodiments which utilize a two-piece mold (e.g., as the molding segments 610) and two-piece curing presses (e.g., as the tire curing press machine 606) are also envisaged.

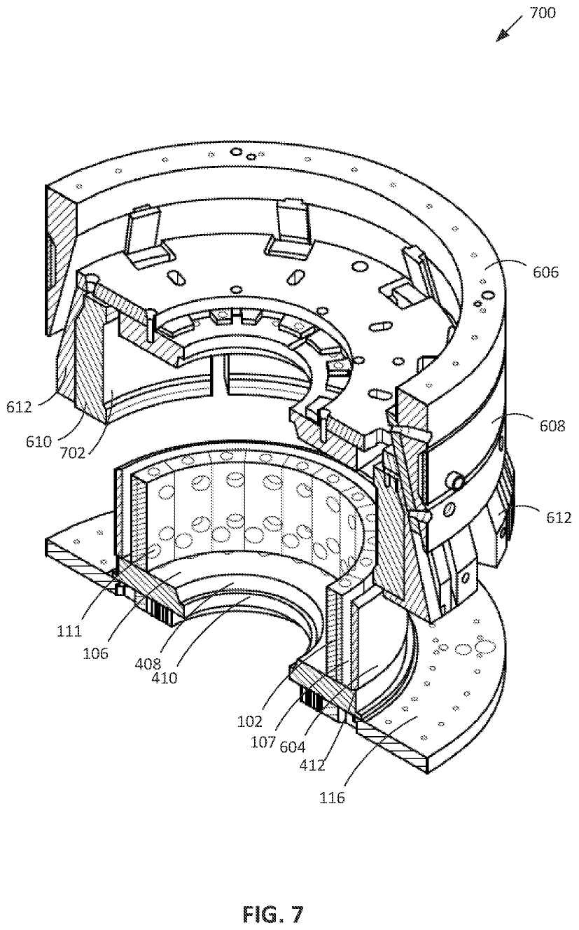

FIG. 7 depicts a partially exploded view of the segmented curing ring 100 during one or more stages of the manufacturing process 600. As shown in FIG. 7, the tire curing press machine 606 and the segmented curing ring 100 can serve as inner and outer mold segments of a tire mold 700 for curing the green band 604 and forming the cured elastomer band (e.g., NPT shear band and/or shear band and tread band assembly). For clarity of image, the positioning of the bladder 602 adjacent to the central axis 114 of the segmented curing ring 100 is not shown. As shown in FIG. 7, the green band 604 is positioned around the outer surface 107 of the plurality of plates 102. As described herein, the plurality of plates 102 can translate along the plurality of channels 104 to transition the segmented curing ring 100 into an expanded state; where the outer surface 107 can be pressed against, and/or provide support for, an inner surface of the green band 604 (e.g., a surface of the green band 604 facing the central axis 114 of the segmented curing ring 100).

Additionally, the tire curing press 606 can be positioned over the segmented curing ring 100 and green band 604. For example, the tire curing press 606 can be positioned onto the one or more wear plates 116 such that the molding surface 702 of the molding segments 610 can be adjacent to an outer surface of the green band 604, where the outer surface can be opposite the inner surface of the green band 604. While FIG. 7 depicts the one or more molding surfaces 702 as smooth surfaces, in various embodiments the one or more molding surfaces 702 can have one or more textured patterns (e.g., as shown in FIG. 9) to impart a desired tread onto the green band 604. Thereby, the green band 604 can be located between a molding surface 702 of the one or more molding segments 610 and the outer surface 107 of the segmented curing ring 100. As described herein, as the actuator 608 engages the wedged surfaces 612, the one or more molding segments 610 (and thereby the one or more molding surfaces 702) can be pressed towards the central axis 114 of the segmented curing ring 100. Thus, the one or more molding segments 610 can be pressed towards each other and against the green band 604 during the manufacturing process 600.

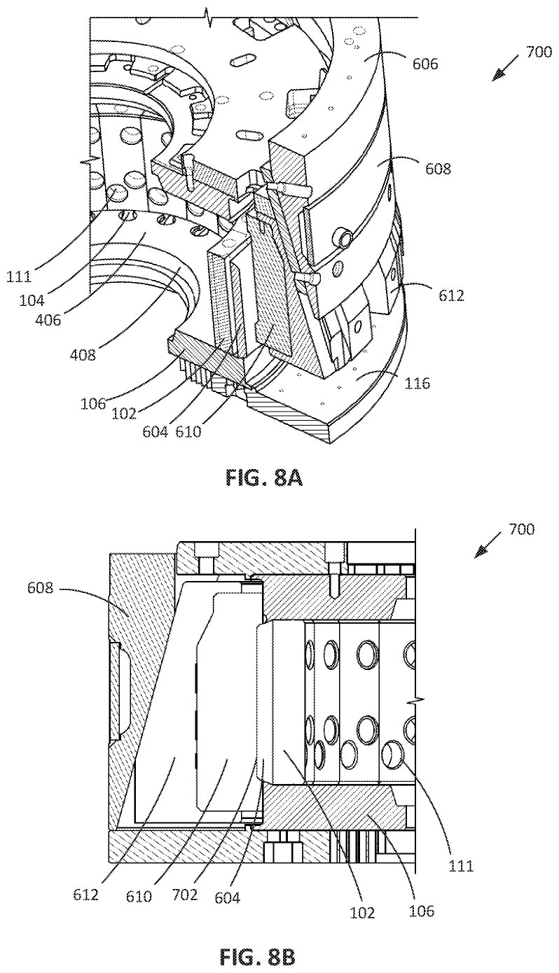

FIG. 8A depicts another partially exploded view of the segmented curing 100 during one or more stages of the manufacturing process 600. In comparison to FIG. 7, FIG. 8A depicts the plurality of plates 102 positioned in a fully expanded state rather than a partially expanded state. For example, portions of the plurality of channels 104 are more readily visible in FIG. 8A, as the plurality of plates 102 have translated along the plurality of channels 104 along the radial direction R.

FIG. 8B depicts the segmented curing ring 100, green band 604, and tire curing press 606 during the manufacturing process 600, where the tire curing press 606 has fully actuated the one or more molding surfaces 610 against the green band 604 during a curing process. As shown in FIG. 8B, the one or more actuated molding surfaces 702 can abut the outer surface (e.g., along the radial direction R) of the green band 604, where the one or more plurality of plates 102 can abut the inner surface (e.g., along the radial direction R) of the green band 604. For clarity of image, the bladder 602 is not shown; however, during this stage of the manufacturing process 600, the bladder 602 can be in an inflated state to maintain the plurality of plates 102 in the expanded state.

As shown in FIG. 8B, the green band 604 can have beveled and/or curved side edges. In one or more embodiments, the beveled side edge of the green band 604 can abut a slanted surface of the ridge 412; such that, as the plurality of plates 102 translate to the expanded state, at least a portion of the a side edge of the green band 604 is sandwiched between the plurality of plates 102 and the ridge 412 (e.g., as shown in FIG. 8B).

FIG. 9 depicts an interior view of the tire curing press 606 in accordance with one or more embodiments described herein. As described herein, the one or more molding surfaces 702 can include one or more ridges, protrusions, grooves, indentations, and/or the like configured to impart a tread pattern into the outer surface of the green band 604 (e.g., into a surface of the green band 604 that is opposite to an inner surface of the green band 604, which abuts the plurality of plates 102 during the manufacturing process 600). In accordance with various embodiments described herein, operation of the tire curing press 606 can press the one or more molding surfaces 702 against the outer surface of the green band 604, thereby imparting a tread pattern and/or curvature to the outer surface of the resultant shear band.

### Additional Embodiments

The present disclosure is also direct to the following exemplary embodiments, which can be practiced in any combination thereof:

Embodiment 1: A tire mold for curing an elastomer band, the tire mold comprising: a base plate having a plurality of channels oriented along a radial direction; a plurality of inner segments configured to engage an inner radius of the elastomer band, wherein each inner segment includes an anchor for reception into a respective channel of the plurality of channels, and wherein the plurality of inner segments are configured to translate along the radial direction; and a plurality of outer segments configured to engage an outer radius of the elastomer band.

Embodiment 2: The tire mold of embodiment 1, wherein the plurality of inner segments include a substantially flat surface configured to impart a flat architecture to the inner radius of the elastomer band in an axial direction that is perpendicular to the radial direction, and wherein the plurality of outer segments include a textured surface configured to impart a tread pattern to the outer radius of the elastomer band during the curing process.

Embodiment 3: The tire mold of embodiments 1 or 2, wherein the plurality of channels include a channel body that houses the anchor and a channel opening on a top surface of the base plate that extends along the radial direction.

Embodiment 4: The tire mold of any of embodiments 1-3, wherein the plurality of inner segments include a first type of inner segment and a second type of inner segment, wherein the first type of inner segment has a projection extending from a sidewall of the first type of inner segment, and wherein the second type of inner segment has a recess extending into a side wall of the second type of inner segment.

Embodiment 5: The tire mold of any of embodiments 1-4, wherein the first type of inner segment is positioned adjacent to the second type of inner segment to form a portion of an outer surface configured to engage the inner radius of the elastomer band.

Embodiment 6: The tire mold of any of embodiments 5, wherein the projection abuts the recess while the first type of inner segment and the second type of inner segment are positioned at an end of the plurality of channels nearest a periphery of the base plate.

Embodiment 7: The tire mold of any of embodiments 1-6, wherein the plurality of plates include a first type of inner segment and a second type of inner segments, wherein the first type of inner segment tapers off toward from the central axis along the radial direction, and wherein the second type of inner segment tapers off away from the central axis along the radial direction.

Embodiment 8: A method for curing a non-pneumatic tire elastomer band, the method comprising: assembling a segmented curing ring comprising a plurality of inner mold segments configured to travel across a base plate along a radial direction; positioning a green elastomer band between the plurality of inner segments and one or more outer mold segments; and exerting an outward pressure on an inner surface of the green elastomer band via the plurality of inner mold segments while exerting an inward pressure on an outer surface of the green elastomer band via the one or more outer mold segments.

Embodiment 9: The method of embodiment 8, further comprising: positioning a tire curing press machine around the green elastomer band and segmented curing ring; and activating the tire curing press machine to cure the green elastomer band and exert the inward pressure.

Embodiment 10: The method of embodiments 8 or 9, wherein the exerting the outward pressure comprises: positioning an inflatable bladder at a central axis of the segmented curing ring; and inflating the inflatable bladder to push the plurality of inner mold segments outwardly along the radial direction and exert the outward pressure.

Embodiment 11: The method of any of embodiments 8-10, wherein the one or more outer mold segments impart a tread pattern onto the outer surface of the green elastomer band, and wherein the plurality of inner mold segments render the inner surface flat along an axial direction that is perpendicular to the radial direction.

Embodiment 12: The method of any of embodiments 8-11, wherein the assembling the segmented curing ring comprises attaching the plurality of inner mold segments to the base plate by inserting anchors extending from bottoms of the plurality of inner mold segments into channels that are recessed into the base plate.

Embodiment 13: The method of any of embodiments 8-13, wherein the channels extend through the base plate along the radial direction.

Embodiment 14: An elastomer band curing ring, comprising: a plurality of plates that are vertically oriented from a base, wherein the plurality of plates are configured to translate across the channels along a radial direction, and wherein the plurality of plates are positioned adjacent to each other to form a shear band molding surface that is substantially flat along an axial direction that is perpendicular to the radial direction.

Embodiment 15: The elastomer band curing ring of embodiment 14, wherein the molding surface faces away from a central axis of the base.

Embodiment 16: The elastomer band curing ring of embodiment 14 or 15, wherein an outer surface of a first plate from the plurality of plates abuts an outer surface of a second plate from the plurality of plates while the plurality of plates are positioned at ends of the channels that are furthest from a central axis of the base.

Embodiment 17: The elastomer band curing ring of any of embodiments 14-16, wherein a portion of the first plate overlaps a portion of the second plate while the plurality of plates are positioned at the ends of the channels.

Embodiment 18: The elastomer band curing ring of any of embodiments 14-18, wherein the plurality of plates are connected to the base via anchors that extend from the plurality of plates into channels recessed into the base.

Embodiment 19: The elastomer band curing ring of any of embodiments 14-19, wherein the plurality of plates include a first type of plate and a second type of plate, wherein the first type of plate has a projection extending from a sidewall of the first type of plate, and wherein the second type of plate has a recess extending into a side wall of the second type of plate.

Embodiment 20: The elastomer band curing ring of any of embodiments 14-19, wherein the plurality of plates include a first type of plate and a second type of plate, wherein the first type of plate tapers off toward from a central axis of the base along the radial direction, and wherein the second type of plate tapers off away from the central axis of the base along the radial direction.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps.

Variations in the present disclosure are possible in light of the description herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire mold for curing an elastomer band, the tire mold comprising:
a base plate having a plurality of channels oriented along a radial direction;
a plurality of inner segments configured to engage an inner radius of the elastomer band, and a plurality of outer segments configured to engage an outer radius of the elastomer band.

2. The tire mold of claim 1 wherein each inner segment includes an anchor for reception into a respective channel of the plurality of channels, and wherein the plurality of inner segments are configured to translate along the radial direction.

3. The tire mold of claim 1, wherein the plurality of inner segments include a substantially flat surface configured to impart a flat architecture to the inner radius of the elastomer band in an axial direction that is perpendicular to the radial direction, and wherein the plurality of outer segments include a textured surface configured to impart a tread pattern to the outer radius of the elastomer band during the curing process.

4. The tire mold of claim 1, wherein the plurality of channels include a channel body that houses the anchor and a channel opening located on a top surface of the base plate that extends along the radial direction.

5. The tire mold of claim 1, wherein the plurality of inner segments include a first type of inner segment and a second type of inner segment, wherein the first type of inner segment has a projection extending from a sidewall of the first type of inner segment, and wherein the second type of inner segment has a recess extending into a side wall of the second type of inner segment.

6. The tire mold of claim 5, wherein the first type of inner segment is positioned adjacent to the second type of inner segment to form a portion of an outer surface configured to engage the inner radius of the elastomer band.

7. The tire mold of claim 5, wherein the projection abuts the recess while the first type of inner segment and the second type of inner segment are positioned at an end of the plurality of channels nearest a periphery of the base plate.

8. The tire mold of claim 1, wherein the plurality of inner segments include a first type of inner segment and a second type of inner segment, wherein the first type of inner segment tapers off toward from a central axis along the radial direction, and wherein the second type of inner segment tapers off away from the central axis along the radial direction.

9. A method for curing a green elastomer band, the method comprising:
assembling a segmented curing ring comprising a plurality of inner mold segments configured to travel across a base plate along a radial direction;
positioning a green elastomer band between the plurality of inner segments and one or more outer mold segments; and
exerting an outward pressure on an inner surface of the green elastomer band via the plurality of inner mold segments while exerting an inward pressure on an outer surface of the green elastomer band via the one or more outer mold segments.

10. The method of claim 9, further comprising:
positioning a tire curing press machine around the green elastomer band and segmented curing ring; and
activating the tire curing press machine to cure the green elastomer band and exert the inward pressure.

11. The method of claim 9, wherein the exerting the outward pressure comprises:
positioning an inflatable bladder at a central axis of the segmented curing ring; and
inflating the inflatable bladder to push the plurality of inner mold segments outwardly along the radial direction and exert the outward pressure.

12. The method of claim 9, wherein the one or more outer mold segments impart a tread pattern onto the outer surface of the green elastomer band, and wherein the plurality of inner mold segments render the inner surface flat along an axial direction that is perpendicular to the radial direction.

13. The method of claim 9, wherein the assembling the segmented curing ring comprises attaching the plurality of inner mold segments to the base plate by inserting anchors extending from bottoms of the plurality of inner mold segments into channels that are recessed into the base plate.

14. The method of claim 13, wherein the channels extend through the base plate along the radial direction.

15. An elastomer band curing ring, comprising:
a plurality of plates that are vertically oriented from a base, wherein the plurality of plates are configured to translate across the channels along a radial direction, and wherein the plurality of plates are positioned adjacent to each other to form an inner molding surface that is substantially flat along an axial direction that is perpendicular to the radial direction.

16. The elastomer band curing ring of claim 15, wherein the inner molding surface faces away from a central axis of the base.

17. The elastomer band curing ring of claim 15, wherein an outer surface of a first plate from the plurality of plates abuts an outer surface of a second plate from the plurality of plates while the plurality of plates are positioned at ends of the channels that are furthest from a central axis of the base.

18. The elastomer band curing ring of claim 17, wherein a portion of the first plate overlaps a portion of the second plate while the plurality of plates are positioned at the ends of the channels.

19. The elastomer band curing ring of claim 15, wherein the plurality of plates are connected to the base via anchors that extend from the plurality of plates into channels recessed into the base.

20. The elastomer band curing ring of claim 15, wherein the plurality of plates include a first type of plate and a second type of plate, wherein the first type of plate has a projection extending from a sidewall of the first type of plate, and wherein the second type of plate has a recess extending into a side wall of the second type of plate.

21. The elastomer band curing ring of claim 15, wherein the plurality of plates include a first type of plate and a second type of plate, wherein the first type of plate tapers off toward from a central axis of the base along the radial direction, and wherein the second type of plate tapers off away from the central axis of the base along the radial direction.
